(19) United States
(12) Patent Application Publication
(10) Pub. No.: US 2026/0155420 A1
(43) Pub. Date: Jun. 4, 2026

(54) ELECTROLYTIC SOLUTION FOR REDOX FLOW BATTERY AND REDOX FLOW BATTERY INCLUDING ELECTROLYTIC SOLUTION

(71) Applicant: Murata Manufacturing Co., Ltd., Nagaokakyo-shi (JP)

(72) Inventors: Naruto MIYAKAWA, Nagaokakyo-shi (JP); Masashi UEBE, Nagaokakyo-shi (JP); Katsuyuki YOUFU, Nagaokakyo-shi (JP); Soichiro TSUJIMOTO, Nagaokakyo-shi (JP); Yusuke TAKARA, Nagaokakyo-shi (JP); Akira OSAKI, Nagaokakyo-shi (JP); Yoichi DEGUCHI, Nagaokakyo-shi (JP)

(21) Appl. No.: 19/456,051

(22) Filed: Jan. 22, 2026

Related U.S. Application Data
(63) Continuation of application No. PCT/JP2024/025791, filed on Jul. 18, 2024.

(30) Foreign Application Priority Data
Aug. 3, 2023 (JP) 2023-127345

(51) Int. Cl. H01M 8/18

(52) U.S. Cl. CPC H01M 8/188; H01M 2300/0014

(57) ABSTRACT

An electrolytic solution for a redox flow battery, the electrolytic solution including: a substance including a metal ion; a water-soluble polymer having at least one coordination moiety on a side chain, wherein the at least one coordination moiety coordinates with the metal ion to form a metal complex; and an aqueous solvent.

### CROSS REFERENCE TO RELATED APPLICATIONS

The present application is a continuation of International application No. PCT/JP2024/025791, filed Jul. 18, 2024, which claims priority to Japanese Patent Application No. 2023-127345, filed Aug. 3, 2023, the entire contents of each of which are incorporated herein by reference.

### TECHNICAL FIELD

The present disclosure relates to an electrolytic solution for a redox flow battery and a redox flow battery including the electrolytic solution.

### BACKGROUND ART

In recent years, redox flow batteries have attracted attention for efficient use of energy from the viewpoint of environmental load saving. The redox flow battery can be used as a battery (storage battery) that stores electric power generated in a power generation unit (for example, power generators utilizing solar, wind, ocean, or geothermal power, and power plants utilizing thermal, nuclear, or hydroelectric power). For example, a redox flow battery connected to a power generator utilizing solar can store power mainly during daytime when sunlight falls, and supply power to a demand part (load unit) at night when sunlight does not fall.

For example, the redox flow battery of Patent Document 1 is an aqueous solution in which a positive electrode electrolytic solution not only includes a manganese redox material as an active material on a positive electrode side but also includes polyethyleneimine.
Patent Document 1: WO 2013/164879 A

### SUMMARY OF THE DISCLOSURE

As a result of intensive studies by the present inventor, it has been found that the performance of the redox flow battery cannot be sufficiently enhanced in the electrolytic solution of Patent Document 1.

The present disclosure has been devised in view of such problems. That is, a main object of the present disclosure is to provide an electrolytic solution for a redox flow battery that further enhances performance of the mounted redox flow battery. In addition, another object of the present disclosure is to provide a redox flow battery including such an electrolytic solution.

An electrolytic solution for a redox flow battery according to an embodiment of the present disclosure includes: a substance including a metal ion; a water-soluble polymer having at least one coordination moiety on a side chain, wherein the at least one coordination moiety coordinates with the metal ion to form a metal complex; and an aqueous solvent.

The redox flow battery according to another embodiment of the present disclosure is a redox flow battery in which an electrolytic solution is circulated between an electric cell and an electrolytic solution tank and charging and discharging are performed by an oxidation-reduction reaction of an active material. The redox flow battery includes: an electric cell having: a first chamber having a first electrode and a first aqueous electrolytic solution in contact with the first electrode; a second chamber having a second electrode and a second aqueous electrolytic solution in contact with the second electrode; and a diaphragm that partitions the first chamber and the second chamber and electrically isolates the first aqueous electrolytic solution and the second aqueous electrolytic solution from each other, and an electrolytic solution tank having: a first electrolytic solution tank that is connected to the first chamber and stores the first aqueous electrolytic solution; and a second electrolytic solution tank that is connected to the second chamber and stores the second aqueous electrolytic solution, in which at least one of the first aqueous electrolytic solution and the second aqueous electrolytic solution is the electrolytic solution for the redox flow battery.

The present disclosure can provide an electrolytic solution for a redox flow battery that further enhances the performance of the mounted redox flow battery. In addition, the present disclosure can provide a redox flow battery including such an electrolytic solution.

### BRIEF EXPLANATION OF THE DRAWINGS

FIG. 1 is a transparent perspective view schematically illustrating a redox flow battery according to a second embodiment.

FIG. 2 is a schematic view illustrating a metal complex (water-soluble redox-active polymer) formed by a water-soluble chelate polymer and a metal ion.

### DESCRIPTION OF THE PREFERRED EMBODIMENTS

Hereinafter, the “electrolytic solution for a redox flow battery” and the “redox flow battery” of the present disclosure will be described in detail. While the description is made with reference to the drawings as necessary, the contents shown in the drawings are only schematically and illustratively shown for understanding the present disclosure, and the appearance, the dimensional ratio, and the like can be different from the actual ones.

The various numerical ranges referred to herein are intended to include the lower limit and upper limit numerical values themselves, for example, unless otherwise noted, such as “less than,” “smaller than,” and “greater than.” That is, taking a numerical range such as 1 to 10 as an example, it is interpreted as including both the lower limit value “1” and the upper limit value “10.”

In the present disclosure, a “battery” refers to a device (secondary battery) that includes a pair of electrodes and an electrolyte, and in particular, is charged and discharged as ions move.

### First Embodiment: Electrolytic Solution for Redox Flow Battery

A first embodiment relates to an electrolytic solution for a redox flow battery (hereinafter, also simply referred to as an “electrolytic solution”).

The electrolytic solution according to the first embodiment includes: a substance including a metal ion (redox active material); a water-soluble polymer (water-soluble chelate polymer) having a coordination moiety in a side chain; and an aqueous solvent, in which the coordination moiety coordinates to the metal ion to form a metal complex.

In the present specification, the electrolytic solution according to the first embodiment is used for a redox flow battery. The “substance (including a metal ion)” included in the electrolytic solution is a substance responsible for oxidation-reduction reaction that causes charge and discharge of the redox flow battery, and may be a substance capable of reversibly exchanging electrons with an electrode (hereinafter, also referred to as “redox active material”). In addition, the water-soluble polymer included in the electrolytic solution can take an aspect of incorporating the above substance. This aspect is, for example, a metal complex, which can reversibly exchange electrons with an electrode. That is, the water-soluble polymer can reversibly exchange electrons with the electrode in an aspect in which the above substance is incorporated. Hereinafter, the water-soluble polymer is also referred to as a “water-soluble chelate polymer.” In addition, a water-soluble polymer incorporating a substance (including a metal ion) is also referred to as a “water-soluble redox-active polymer.”

### [Mechanism of Action]

The electrolytic solution according to the first embodiment can further enhance the performance of the mounted redox flow battery. The reason is presumed as described below.

The electrolytic solution according to the first embodiment includes a water-soluble chelate polymer. The water-soluble chelate polymer has high solubility in an electrolytic solution and thus can incorporate a metal complex that is formed with a metal ion as a redox active material. This allows the oxidation-reduction reaction in the electrode to proceed in an aspect in which the metal complex is incorporated into the water-soluble chelate polymer. Therefore, the electrolytic solution according to the first embodiment can further enhance the performance of the mounted redox flow battery.

[how the Present Disclosure has been Conceived]

As a result of intensive studies on the prior art described in Patent Document 1, the present inventors have obtained technical knowledge that polyethyleneimine is not sufficiently high in solubility in an electrolytic solution, thus failing to sufficiently form a metal complex with a manganese redox material in an electrolytic solution, and failing to sufficiently enhance performance of a redox flow battery equipped with such an electrolytic solution.

As a result of continuous studies based on the above technical knowledge, the present inventors have arrived at the configuration of the present disclosure in which the performance of a redox flow battery is further enhanced by enhancing the water solubility of a chelate polymer.

The electrolytic solution for a redox flow battery is preferably an alkaline aqueous solution from the viewpoint of suppressing the oxidation-reduction reaction of water and forming a significant potential difference. The pH of the electrolytic solution for a redox flow battery is, for example, more than 7 and 13 or less. The upper limit value of the pH is preferably a pH at which the peptide derivative as the water-soluble chelate polymer is less likely to cause pH denaturation (alkali denaturation).

The redox potential difference may be formed by the selection of (the coordination moieties included in) the redox active material and the water-soluble chelate polymer, and the combination of the first and second aqueous electrolytic solution composed thereof, depending on the desired application and performance of the redox flow battery. For example, a combination of an iron ion and a coordination moiety leads to the coordination moiety derived from a compound having a coordination moiety derived from iron-polyalcohol, a coordination moiety derived from iron-amine carboxylic acid, an iron-cyano group, and a coordination moiety derived from iron-pyridine in the ascending order of potentials.

### (Redox Active Material)

The redox active material is a material that causes an oxidation reaction or a reduction reaction. The redox active material includes a metal ion. A certain metal ion can cause an oxidation reaction to increase its valence. Another metal ion can also cause a reduction reaction and reduce its valence.

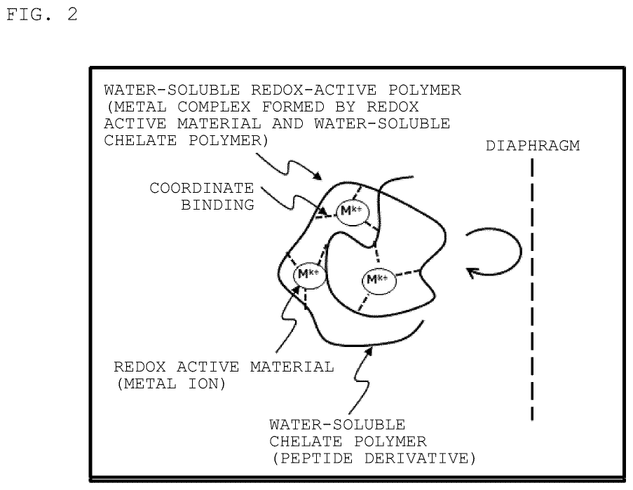

The redox active material forms a metal complex with the water-soluble chelate polymer. The metal ion included in the redox active material forms a coordinate bond with the coordination moiety of the water-soluble chelate polymer to form a metal complex. The metal ion is incorporated in an aspect in which a metal complex is formed in the water-soluble chelate polymer and is present in the electrolytic solution. The metal ion causes an oxidation reaction or a reduction reaction between the electrodes in a state of being incorporated in the water-soluble chelate polymer (refer to FIG. 2 described later).

In a preferred aspect, the metal ion is an ion of one metal selected from the group consisting of Zn, Fe, Ti, Cu, Co, V, Ce, Cr, and Mn, if more emphasis is placed on achieving various potentials of the electrolytic solution. The metal ion may be an ion of one metal selected from the group consisting of Zn, Fe, Ti, Cu, Co, Ce, Cr, and Mn. Among these, the metal ion is more preferably an ion of one metal selected from the group consisting of Zn, Fe, Ti, Cu, Cr, and Mn, and further preferably an ion of one metal selected from the group consisting of Zn, Fe, Cr, and Mn, if more emphasis is placed on reducing the production cost of the electrolytic solution. In a more preferred aspect, the metal ion is an iron ion.

### (Water-Soluble Chelate Polymer)

Water solubility of a water-soluble chelate polymer refers herein to the mass (solubility (g/L)) of a polymer that is soluble in an aqueous solvent per unit volume. This solubility is measured as follows. The polymer material is mixed and diffused with any volume of an aqueous solvent, and the presence or absence of white turbidity and/or precipitation is visually evaluated. A material having a higher solubility as long as turbidity or precipitation does not occur is more excellent in water solubility. Herein, the water solubility of the water-soluble chelate polymer refers to a solubility of 8 g/L or more, preferably 10 g/L.

The water-soluble chelate polymer has a coordination moiety in a side chain. In other words, the water-soluble chelate polymer has a (binding) moiety on the side chain. That is, the water-soluble chelate polymer can have a main chain and a moiety (side chain moiety) corresponding to a side chain with respect to the main chain. The water-soluble chelate polymer can incorporate metal ions in an electrolytic solution. In an aspect in which the water-soluble chelate polymer incorporates a metal ion, the metal ion and the coordination moiety of the water-soluble chelate polymer interact (for example, electrostatic attraction) with each other. More specifically, in the electrolytic solution, the water-soluble chelate polymer forms a metal complex with a metal ion. That is, the coordination moiety of the water-soluble chelate polymer is coordinated to the metal ion to form a metal complex.

The water-soluble chelate polymer may have repeating units. In this case, the number of repeating units in the water-soluble chelate polymer is not particularly limited as long as the effect of the present disclosure is exhibited. For example, the water-soluble chelate polymer may be an oligomer having two or more repeating units.

The water-soluble chelate polymer has a plurality of coordination moieties and is monodentate or bidentate to a metal ion to form a metal complex. The types of these plurality of coordination moieties may be the same or different from each other. The water-soluble chelate polymer includes a plurality of different coordination moieties as coordination moieties, which are likely to modulate the redox potential.

The water-soluble chelate polymer incorporates a metal ion in an aspect in which a metal complex is formed. The coordination moiety forms a metal complex with a metal ion in a state of being bonded to the water-soluble chelate polymer. A mechanism for suppressing diffusion of the coordination moiety will be described with reference to FIG. 2. FIG. 2 is a schematic view illustrating a metal complex (water-soluble redox-active polymer) formed by a water-soluble chelate polymer and a redox active material (metal ion) (in FIG. 2, a peptide derivative is exemplified as an example of the water-soluble chelate polymer, and k in M^{k+} indicating a metal ion represents a positive integer, for example, represents an absolute value of a valence that can be taken by a metal atom such as Zn, Fe, Ti, Cu, Ce, Cr, and Mn). As illustrated in FIG. 2, the molecular weight of the water-soluble chelate polymer including the coordination moiety is much larger than that of the ligand (ligand alone), and the water-soluble chelate polymer hardly permeates and diffuses through the diaphragm. For this reason, in the redox flow battery on which the electrolytic solution according to the first embodiment is mounted, deterioration in performance of the redox flow battery due to diffusion of the coordination moiety is significantly suppressed.

Examples of the coordination moiety include at least one coordination moiety derived from a ligand to which a nitrogen atom, an oxygen atom, and a carbon atom are coordinated, and a coordination moiety including a functional group to which a nitrogen atom, an oxygen atom, and a carbon atom are coordinated. Such ligands may be derivatives of the following exemplary ligands (more specifically, salts of the following ligands, ions in which the counter ions are dissociated, and ligands into which reactive functional groups are introduced).

Examples of the ligands to which a nitrogen atom and an oxygen atom are coordinated include aminopolycarboxylic acids and polyalcoholamines. Examples of the aminopolycarboxylic acid include ethylenediaminetetraacetic acid (EDTA), ethylenediaminebis (2-hydroxyphenyl) acetic acid (EDDHA), nitrilotriacetic acid (NTA), diethylenetriaminepentaacetic acid (DTPA), N-(2-hydroxyethyl)ethylenediamine-N,N′,N′-triacetic acid (HEDTA), triethylenetetramine-N,N,N′,N″,N′″,N′″-hexaacetic acid (TTHA), trimethylenediamine-N,N,N′,N′-tetraacetic acid (PDTA), 1,3-diamino-2-propanol-N,N,N′,N′-tetraacetic acid (DPTA-OH), N-(2-hydroxyethyl)iminodiacetic acid (HIDA), N,N-bis(2-hydroxyethyl)glycine (DHEG), glycol ether diamine tetraacetic acid (GEDTA), glutamic acid diacetic acid (CMGA), ethylenediamine-N,N′-disuccinic acid (EDDS), N,N′-di(2-hydroxybenzyl)ethylenediamine-N,N′-diacetic acid (HBED), glycine, and sarcosinic acid.

Examples of the polyalcoholamine include triethanolamine.

Examples of the ligands to which an oxygen atom is coordinated include a hydroxycarboxylic acid, a polycarboxylic acid, and a polyol. Examples of the hydroxycarboxylic acid include citric acid, gluconic acid, glycolic acid, hydroxybutanoic acid, lactic acid, and salicylic acid.

Examples of the polycarboxylic acid include maleic acid and phthalic acid.

Examples of the polyol include glycol, catechol, and ascorbic acid.

Examples of the ligands to which a nitrogen atom is coordinated include pyridine, bipyridine, tripyridine, phenanthroline, polyethyleneimine (polymerization degree from ethyleneimine: 2 to 5), and a compound having a cyano group (cyano compound).

Examples of the ligands to which a carbon atom is coordinated include cyclopentadienyl.

Examples of the functional group to which a nitrogen atom, an oxygen atom, and a carbon atom are coordinated include a hydroxy group, a carboxy group, a phosphate group, a sulfo group, a phenol group, and a pyridine group.

Preferably, the coordination moiety is at least one coordination moiety derived from a ligand selected from the group consisting of, among the above compounds, ethylenediaminetetraacetic acid (EDTA), ethylenediaminebis (2-hydroxyphenyl)acetic acid (EDDHA), diethylenetriaminepentaacetic acid (DTPA), and triethanolamine (TEOA), and/or a coordination moiety including at least one functional group selected from the group consisting of a hydroxy group, a carboxy group, a phosphate group, a sulfo group, a phenol group, and a pyridine group.

A plurality of coordination moieties included in one molecule of the water-soluble chelate polymer may be different. In such a case, the redox potential of the electrolytic solution for a redox flow battery is likely to be finely adjusted by the combination of the coordination moieties (it becomes easier to prepare the electrolytic solution at the desired potential).

The water-soluble chelate polymer preferably includes a nitrogen atom and an oxygen atom. More specifically, the coordination moiety preferably includes a nitrogen atom and an oxygen atom. When the water-soluble chelate polymer is a polyamine derivative described later and an oxygen atom is included in the coordination moiety of the polyamine derivative, the solubility of the water-soluble chelate polymer can be further enhanced by both effects (that is, the effect by zwitterionic property) of the cationic nature of the nitrogen atom constituting the polyamine derivative and the anionic nature of the oxygen atom contained in the coordination moiety.

When the water-soluble chelate polymer is a peptide derivative described later (the peptide derivative includes an amide bond (peptide bond) composed of a nitrogen atom and an oxygen atom), high water solubility of the main chain of the water-soluble chelate polymer is expected due to a nitrogen atom and an oxygen atom included in the amide bond. In addition, when a peptide derivative derived from a plurality of types of amino acids is employed as the water-soluble chelate polymer, it becomes easier to introduce different coordination moieties to each of the plurality of types of functional groups of the plurality of types of amino acids. This makes it possible to finely adjust the specification according to the application of the redox flow battery.

In particular, when the peptide derivative includes a repeating unit derived from lysine, the peptide derivative can be prepared by introducing a coordination moiety into the peptide while maintaining high water solubility using the terminal amino group of the side chain of the repeating unit derived from lysine. Further, when the coordination moiety to be introduced into the repeating unit derived from lysine in the peptide includes an oxygen atom, not only the nitrogen atom and the oxygen atom included in the main chain of the water-soluble chelate polymer but also the nitrogen atom and the oxygen atom included in the side chain can greatly increase the water solubility of the water-soluble chelate polymer.

Examples of the water-soluble chelate polymer include peptide derivatives and polyamine derivatives.

### Polyamine Derivative

The polyamine derivative is obtained by introducing a coordination moiety into a terminal amino group of a polyamine. Such a coordination moiety is, for example, a coordination moiety in the water-soluble chelate polymer described above. The raw material of such a coordination moiety is, for example, one having a functional group having reactivity with a terminal amino group on a ligand for forming a coordination moiety in the water-soluble chelate polymer described above.

The polyamine derivative can be obtained by introducing a desired coordination moiety while maintaining the dispersibility of the raw material polymer (polyamine) and increasing the water solubility in a mild environment around pH neutrality. Examples of the polyamine derivative include polyethyleneimine derivatives.

### Peptide Derivative

The water-soluble chelate polymer is preferably a peptide derivative. The peptide derivative has a main chain composed of repeating units derived from amino acids and a side chain composed of a coordination moiety. The peptide derivative is, for example, a compound in which a ligand is bonded to a side chain of the peptide. The peptide derivative preferably includes repeating units derived from lysine. More specifically, the peptide derivative includes a main chain derived from lysine (α-poly-L-lysine and ε-poly-L-lysine), and more preferably has ε-poly-L-lysine as a main chain.

The molecular weight of the water-soluble chelate polymer (peptide derivative) is, for example, 500 to 50,000. The method for measuring the degree of polymerization is size exclusion chromatography.

The water solubility of the peptide derivative is based on an amide bond (peptide bond) of the main chain and may be based on a side chain. The peptide derivative has a coordination moiety on a side chain, but may have a water-soluble functional group on another side chain. In addition, the coordination moiety itself may be a water-soluble functional group.

The water solubility of the peptide derivative can be prepared by introducing an amide bond (peptide bond) and a water-soluble functional group. For example, when a peptide derivative is synthesized using any of 9 essential amino acids (valine, isoleucine, leucine, methionine, lysine, phenylalanine, threonine, and histidine) and 11 non-essential amino acids (arginine, glycine, alanine, serine, tyrosine, cysteine, asparagine, glutamine, proline, aspartic acid, and glutamic acid), examples thereof include leucine, threonine, glutamic acid, aspartic acid, lysine, and cysteine having a water-soluble functional group (more specifically, —OH, —COOH, NH₂, —SH, —CONH₂, or the like) that does not contribute to formation of an amide bond of a peptide derivative.

In addition, the degree of water solubility of the peptide derivative can be adjusted by the ratio (molar ratio) of the amino acid having a water-soluble functional group to the amino acid having a hydrophobic functional group as a raw material of the peptide derivative. Examples of the amino acid having a hydrophobic functional group include an amino acid having an alkylene group (glycine, alanine, valine, leucine, and Isoleucine).

These water-soluble functional groups are also used for introduction of ligands in synthesis of peptide derivatives because they have reactive activity. For example, when the water-soluble functional group is an amino group and the ligand has a carboxyl group, they react to form an amide bond, causing the ligand to be introduced into the side chain of the peptide to form a peptide derivative.

### Method for Synthesizing Peptide Derivative

An example of a method for synthesizing a peptide derivative will be described. Peptides are synthesized by condensation polymerization of amino acids. Herein, the amino acid as a raw material includes at least an amino group having a reactive functional group for introducing a ligand (for example, leucine, threonine, glutamic acid, aspartic acid, lysine, cysteine, and the like) in addition to at least one amino group and one carboxyl group for synthesizing a peptide. In the synthesis of the peptide, from the viewpoint of accelerating the condensation polymerization reaction, a water-soluble condensing agent (more specifically, 1-ethyl-3-[3-(dimethylamino)propyl]carbodiimide and the like) may be further included in addition to the amino acid as a raw material.

As the peptide, a commercially available peptide may be used.

The water-soluble functional group of at least a part of the side chain of the obtained peptide is reacted with a ligand to bond the ligand to the side chain of the peptide, and a coordination moiety is introduced to synthesize a peptide derivative. A reactive functional group capable of reacting with the water-soluble functional group of the side chain may be introduced into the ligand or a derivative thereof (more specifically, a salt of the ligand, and the like).

In these reactions, the reaction time is, for example, 1 to 10 hours, and the reaction temperature is, for example, room temperature (25° C.) to 30° C. In addition, the upper limit of the reaction temperature is a temperature at which the peptide as a raw material and the produced peptide derivative are not denatured (thermally denatured).

### (Aqueous Solvent)

An aqueous solvent herein includes 95 weight % or more, 97 weight % or more, 99 weight % or more, or 100 weight % or more of water. The aqueous solvent may include a water-soluble solvent in addition to water. The water-soluble solvent is a solvent miscible with water. Examples of the water-soluble solvent include alcohols (more specifically, monoalcohols, such as methanol, and glycols, such as ethylene glycol) and ethers such as tetrahydrofuran.

### Second Embodiment: Redox Flow Battery

A second embodiment relates to a redox flow battery. In the redox flow battery according to the second embodiment, an aqueous electrolytic solution is circulated between an electric cell and an electrolytic solution tank, and charging and discharging are performed by an oxidation-reduction reaction of a redox active material.

Hereinafter, the second embodiment will be specifically described, but portions overlapping with the disclosure of the first embodiment may be omitted. In addition, in the second embodiment, a member related to the positive electrode (anode) is applied to a member denoted by the term “first” and a member denoted by a reference numeral including “A.” On the other hand, a member related to the negative electrode (cathode) is applied to a member denoted by the term “second” and a member denoted by a reference numeral including “B.”

### [Function]

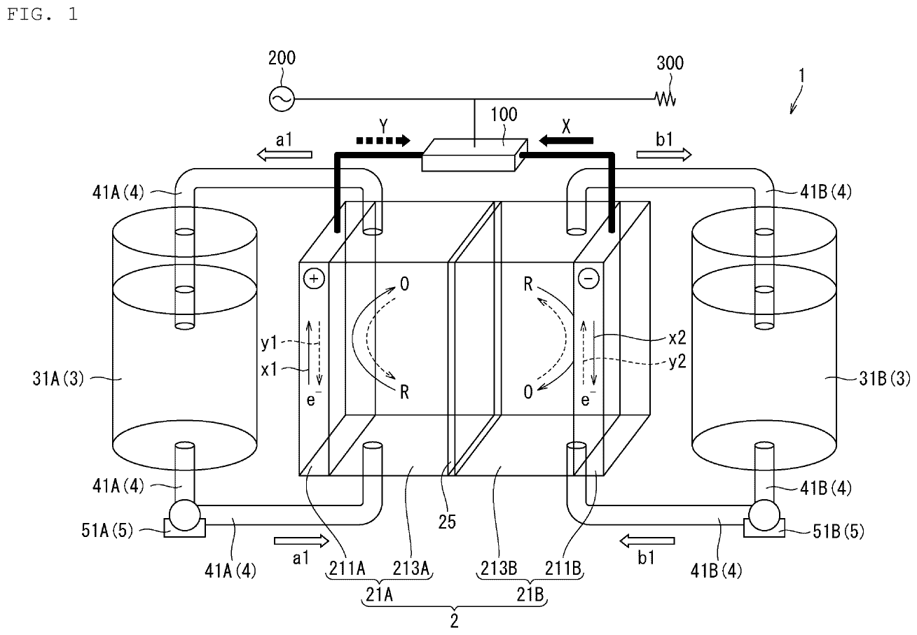

A redox flow battery according to a second embodiment will be described with reference to FIG. 1. FIG. 1 is a transparent perspective view illustrating a redox flow battery according to the second embodiment.

The redox flow battery 1 according to the second embodiment is a secondary battery. As illustrated in FIG. 1, the redox flow battery 1 is electrically connected to a power generation unit 200 and a load unit 300 via a power converter (power conditioner (inverter), DC/AC converter) 100.

During charging the redox flow battery 1, a current flows as indicated by a solid arrow represented by X. The power generation unit 200 (for example, power generators utilizing solar, wind, ocean, or geothermal power, and power plants utilizing thermal, nuclear, or hydroelectric power) generates electric power. When power is generated by the power generation unit 200 that performs AC power generation, the AC current supplied from the power generation unit 200 is converted into a DC current by the power converter 100. The converted DC current is supplied to the redox flow battery 1. Thus, the redox flow battery 1 is charged. On the other hand, when power is generated by power generation unit (for example, a power generator utilizing sunlight) 200 that performs DC power generation, the DC current supplied from the power generation unit 200 is supplied to the redox flow battery 1. Thus, the redox flow battery 1 is charged.

During discharging of the redox flow battery 1, a current flows as indicated by a broken line arrow represented by Y. The load unit 300 (for example, a factory and a house) consumes power. A DC current supplied from the redox flow battery 1 is converted into an AC current by the power converter 100. The converted AC current is supplied to the load unit 300. Thus, the redox flow battery 1 is discharged.

### [Configuration]

As illustrated in FIG. 1, the redox flow battery 1 includes an electric cell 2 and an electrolytic solution tank 3. The redox flow battery 1 is electrically connected to an external power generation unit 200 and a load unit 300 by a first electrode 211A and a second electrode 211B of the electric cell 2. The electric cell 2 is fluidly connected to the electrolytic solution tank 3, and the electrolytic solution 23 is supplied in a recirculating manner from the electrolytic solution tank 3 to the electric cell 2. In addition, the redox flow battery 1 further includes an electrolytic solution circulation path 4 and a pump 5.

### (Electric Cell)

The electric cell 2 includes a first chamber 21A, a second chamber 21B, and a diaphragm 25. The electric cell 2 is partitioned into the first chamber 21A and the second chamber 21B by the diaphragm 25.

### First Chamber

A first chamber (positive electrode chamber, anode chamber) 21A is a chamber partitioned by a catholyte. The first chamber 21A is disposed to face the second chamber 21B with respect to the diaphragm 25. The first chamber 21A includes a first electrode 211A and a first aqueous electrolytic solution (aqueous positive electrolytic solution, aqueous catholyte) 213A. The first chamber 21A is fluidly connected to a first electrolytic solution tank 31A via a first electrolytic solution circulation path 41A. In the first chamber 21A, the first aqueous electrolytic solution 213A is supplied in a recirculating manner from the first electrolytic solution tank 31A along the direction of the arrow al by an electrolytic solution circulation pump 5 (first electrolytic solution circulation pump 51A).

### First Electrode

A first electrode 211A functions as a positive electrode during discharging the redox flow battery 1, and in the first electrode 211A, a reduction reaction occurs as represented by a semi-reaction formula (1):

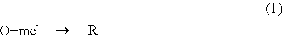

In the semi-reaction formula (1), 0 represents an oxidant, R represents a reductant, and m represents an integer of 1 or more. In this reduction reaction, electrons move in a direction represented by a broken line arrow y1 in FIG. 1. That is, the first electrode 211A transfers electrons to an oxidant (metal ions of the positive electrode active material in the first aqueous electrolytic solution 213A), and the oxidant is reduced to become a reductant.

The first electrode 211A functions as an anode during charging the redox flow battery 1, and in the first electrode 211A, an oxidation reaction occurs as represented by a semi-reaction formula (2):

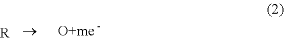

In the semi-reaction formula (2), O represents an oxidant, R represents a reductant, and m represents an integer of 1 or more. In this oxidation reaction, electrons move in a direction represented by a solid arrow x1 in FIG. 1. That is, the first electrode 211A receives electrons from the reductant (metal ions of the positive electrode active material in the first aqueous electrolytic solution 213A), and the reductant is oxidized to become an oxidant.

The first electrode 211A may include a positive electrode active material. The positive electrode active material may include elements of metal ions included in the first aqueous electrolytic solution 213A.

### First Aqueous Electrolytic Solution

The first aqueous electrolytic solution 213A may be the electrolytic solution for a redox flow battery according to the first embodiment. However, at least one of the first aqueous electrolytic solution 213A and the second aqueous electrolytic solution 213B is the electrolytic solution for a redox flow battery according to the first embodiment.

### Second Chamber

The second chamber (negative electrode chamber, cathode chamber) 21B is a chamber partitioned by an anolyte. The second chamber 21B is disposed to face the first chamber 21A with respect to the diaphragm 25. The second chamber 21B includes a second electrode 211B and a second aqueous electrolytic solution (aqueous negative electrolyte solution, aqueous anolyte) 213B. The second chamber 21B is fluidly connected to the electrolytic solution tank 3 (second electrolytic solution tank 31B) via the electrolytic solution circulation path 4 (second electrolytic solution circulation path 41B). In the second chamber 21B, the second aqueous electrolytic solution 213B is supplied in a recirculating manner from the electrolytic solution tank 3 (second electrolytic solution tank 31B) along the direction of arrow bl by the electrolytic solution circulation pump 5 (second electrolytic solution circulation pump 51B).

### Second Electrode

The second electrode 211B functions as a negative electrode during discharging the redox flow battery 1, and in the second electrode 211B, an oxidation reaction occurs as represented by the semi-reaction formula (2). In this oxidation reaction, electrons move in a direction represented by a broken line arrow y2 in FIG. 1. That is, the second electrode 211B receives electrons from the reductant (metal ions of the negative electrode active material in the first aqueous electrolytic solution 213A), and the reductant is oxidized to become an oxidant.

The second electrode 211B functions as a negative electrode during charging the redox flow battery 1, and in the second electrode 211B, a reduction reaction occurs as represented by the semi-reaction formula (1). In this reduction reaction, electrons move in a direction represented by a solid arrow x2 in FIG. 1. That is, the second electrode 211B transfers electrons to an oxidant (metal ions of the negative electrode active material in the second aqueous electrolytic solution 213B), and the oxidant is reduced to become a reductant.

The second electrode 211B may include a negative electrode active material. The negative electrode active material may include elements of metal ions included in the second aqueous electrolytic solution 213B.

### Second Aqueous Electrolytic Solution

The second aqueous electrolytic solution 213B may be the electrolytic solution for a redox flow battery according to the first embodiment. However, at least one of the first aqueous electrolytic solution 213A and the second aqueous electrolytic solution 213B is the electrolytic solution for a redox flow battery according to the first embodiment.

### Diaphragm

The diaphragm (separator) 25 separates and isolates the first chamber 21A and the second chamber 21B, and electrically isolates the first aqueous electrolytic solution 213A and the second aqueous electrolytic solution 213B from each other. The diaphragm 25 is interposed between the positive electrode 21A and the negative electrode 21B. The diaphragm 25 allows permeation of only specific chemical species (for example, protons, hydroxide ions, and oxide ions).

The diaphragm 25 may be, for example, a porous membrane and an ion exchange membrane (more specifically, a cation exchange membrane, an anion exchange membrane, and the like).

### (Electrolytic Solution Tank)

The electrolytic solution tank 3 stores an electrolytic solution, and supplies the electrolytic solution to the electric cell 2 in a recirculating manner. The electrolytic solution tank 3 has the first electrolytic solution tank 31A and the second electrolytic solution tank 31B. The electrolytic solution tank 3 has, for example, a two-layer structure including a first layer disposed inside the electrolytic solution tank 3 and a second layer disposed outside the first layer. The first layer imparts insulating properties to the inside of the electrolytic solution tank 3, and includes, for example, a resin. The second layer imparts strength to the electrolytic solution tank 3 and includes, for example, metal.

### First Electrolytic Solution Tank

The first electrolytic solution tank 31A is an electrolytic solution storage layer that stores the first aqueous electrolytic solution 213A. The first electrolytic solution tank 31A is fluidly connected to the first chamber 21A, and supplies the first aqueous electrolytic solution 213A to the first chamber 21A in a recirculating manner.

### Second Electrolytic Solution Tank

The second electrolytic solution tank 31B is an electrolytic solution storage layer that stores the second aqueous electrolytic solution 213B. The second electrolytic solution tank 31B is fluidly connected to the second chamber 21B, and supplies the second aqueous electrolytic solution 213B to the second chamber 21B in a recirculating manner.

### (Electrolytic Solution Circulation Path)

The electrolytic solution circulation path 4 connects the electrolytic solution tank 3 and the electric cell 2, and is a path through which the electrolytic solution is supplied in a recirculating manner. The electrolytic solution circulation path 4 has, for example, a two-layer structure including a first layer disposed inside the electrolytic solution circulation path and a second layer disposed outside the first layer. The first layer is disposed inside the path, imparts insulating properties to the electrolytic solution circulation path 4, and includes, for example, a resin. The second layer imparts strength to the electrolytic solution circulation path 4 and includes, for example, metal.

The electrolytic solution circulation path 4 includes the first electrolytic solution circulation path 41A and the second electrolytic solution circulation path 41B. The first electrolytic solution circulation path 41A connects the first chamber 21A and the first electrolytic solution tank 31A, and is a path through which the first aqueous electrolytic solution 213A is supplied in a recirculating manner. The second electrolytic solution circulation path 41B connects the second chamber 21B and the second electrolytic solution tank 31B, and is a path through which the second aqueous electrolytic solution 213B is supplied in a recirculating manner.

### (Pump)

The pump 5 is a circulation pump that supplies an electrolytic solution in a recirculating manner. The pump 5 has the first electrolytic solution circulation pump 51A and the second electrolytic solution circulation pump 51B. The first electrolytic solution circulation pump 51A supplies the first aqueous electrolytic solution 213A between the first chamber 21A and the first electrolytic solution tank 31A in a recirculating manner. The second electrolytic solution circulation pump 51B supplies the second aqueous electrolytic solution 213B between the second chamber 21B and the second electrolytic solution tank 31B in a recirculating manner.

### [Preferred Aspect]

In a preferred aspect, the first aqueous electrolytic solution 213A and the second aqueous electrolytic solution 213B are the electrolytic solution for a redox flow battery according to the first embodiment, and the redox active materials included in both the first aqueous electrolytic solution 213A and the second aqueous electrolytic solution 213B are the same.

In the present aspect, the redox active materials are of the same type, and thus although the redox active material permeates the diaphragm 25, the redox active material functions as a redox active material on the permeated side. Therefore, in the present aspect, although the redox active material permeates, the function of the redox flow battery 1 is hardly deteriorated.

In another preferred aspect, in the above preferred aspect, the coordination moieties of the water-soluble chelate polymer included in both the first aqueous electrolytic solution 213A and the second aqueous electrolytic solution 213B are different.

In this aspect, although the first aqueous electrolytic solution 213A and the second aqueous electrolytic solution 213B include the same redox active material, a significant potential difference can be formed by selecting and combining coordination moieties of different water-soluble chelate polymers. As described above, in the present aspect, it is possible to secure the degree of freedom in design while suppressing deterioration of the function of the redox flow battery 1 due to permeation of the redox active material.

In still another preferred aspect, the first aqueous electrolytic solution 213A and the second aqueous electrolytic solution 213B are the electrolytic solution for a redox flow battery according to the first embodiment, the coordination moieties of the water-soluble chelate polymers included in both the first aqueous electrolytic solution 213A and the second aqueous electrolytic solution 213B are the same, and the redox active materials included in both the first aqueous electrolytic solution 213A and the second aqueous electrolytic solution 213B are ions of at least one metal selected from the group consisting of Zn, Fe, Ti, Cu, Co, Ce, Cr, and Mn, respectively, and are different from each other.

In the present aspect, the first aqueous electrolytic solution 213A and the second aqueous electrolytic solution 213B include the same type of water-soluble chelate polymer, and thus the cost can be reduced. On the other hand, a significant potential difference can be formed only by selecting and combining different redox active materials. As described above, in the present aspect, it is possible to secure the degree of freedom in design while reducing the cost.

### EXAMPLES

Hereinafter, the present disclosure will be described more specifically with reference to Examples; however, the present disclosure is not limited to these Examples.

### Example 1

### [1. Preparation of Reagent]

In the preparation of the aqueous electrolytic solution, the following reagents are used.

### (Amino Acid)

Lysine, manufactured by Tokyo Chemical Industry Co., Ltd.

### (Water-Soluble Condensing Agent)

1-Ethyl-3-[3-(dimethylamino)propyl]carbodiimide, manufactured by Tokyo Chemical Industry Co., Ltd.

### (Ligand)

Ethylenediaminetetraacetic acid (EDTA) tetrasodium dihydrate, manufactured by Tokyo Chemical Industry Co., Ltd.
N,N-bis(2-hydroxyethyl)glycine (DHEG), manufactured by Tokyo Chemical Industry Co., Ltd.

### (Redox Active Material)

Iron (III) chloride hexahydrate (salt of iron), manufactured by FUJIFILM Wako Pure Chemical Corporation
Manganese (II) chloride tetrahydrate (salt of manganese), manufactured by FUJIFILM Wako Pure Chemical Corporation

### (Solvent)

Deionized water

### (Alkali Modifier)

Sodium hydroxide, manufactured by Tokyo Chemical Industry Co., Ltd.

### [2. Synthesis of Water-Soluble Chelate Polymer]

A peptide derivative [1] is synthesized as a water-soluble chelate polymer. Lysine as an amino acid, 1-ethyl-3-[3-(dimethylamino)propyl]carbodiimide as an aqueous condensing agent, and deionized water are mixed and subjected to condensation polymerization. This forms an amide bond (peptide bond) to synthesize a peptide. The obtained peptide is purified with a column to obtain ε-poly-L-lysine as a peptide.

ε-Poly-L-lysine as the obtained peptide and ethylenediaminetetraacetic acid were mixed and stirred under the conditions of a molar ratio (ε-poly-L-lysine:ethylenediaminetetraacetic acid) of 1:1, room temperature (25° C.) and 5 hours. This reaction is a dehydration condensation reaction represented as the following reaction formula:

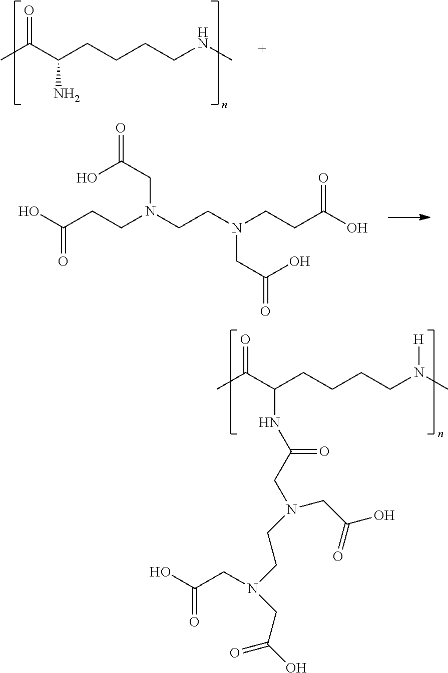

In the above reaction formula, n represents the degree of polymerization and represents a positive integer, in which a primary amino group (—NH₂) of the side chain of s-poly-L-lysine and a carboxyl group (—COOH) of ethylenediaminetetraacetic acid form an amide bond. This synthesizes the peptide derivative [1] in which EDTA is bonded to the side chain of ε-poly-L-lysine via an amide bond. The solubility of the peptide derivative [1 is 10 g/L.

### [3. Preparation of Electrolytic Solution]

### (Catholyte: First Aqueous Electrolytic Solution)

Iron chloride (salt of iron) including a redox active material, deionized water (solvent) as a solvent, and sodium hydroxide as an alkali adjusting agent are stirred using a stirrer (mixer) to obtain an iron (III) aqueous solution-based electrolytic solution (pH=8). The obtained electrolytic solution was referred to as a catholyte (first aqueous electrolytic solution).

### (Anolyte: Second Aqueous Electrolytic Solution)

The obtained peptide derivative [1] as a Redox active polymer, iron chloride (salt of iron) including a redox active material, deionized water as a solvent, and sodium hydroxide as an alkali adjusting agent are stirred using a stirrer (mixer) to obtain an iron (II)-polylysine EDTA aqueous solution-based electrolytic solution (pH=8). The obtained electrolytic solution is referred to as an anolyte (second aqueous electrolytic solution).

### [4. Fabrication of Redox Flow Battery]

### (Preparation of Electric Cell)

An electric cell as illustrated in FIG. 1 is fabricated. The electric cell has a substantially cubic shape, and is configured by connecting two substantially rectangular parallelepiped shapes. In a state where the diaphragm is clamped between flanges (not illustrated) of two substantially rectangular parallelepiped glass containers, the flanges are clamped and fixed with screws. This forms a substantially cubic container having two spaces separated by the diaphragm. Two substantially rectangular parallelepiped spaces in this substantially cubic container correspond to a first chamber and a second chamber, respectively. In each of the two substantially rectangular parallelepiped spaces, an electrode (carbon plate electrode) is provided on an inner wall surface facing the partition wall. Further, in each of the first chamber and the second chamber, a first opening portion is disposed on the upper surface of the substantially rectangular parallelepiped shape, and a second opening portion is disposed on the lower surface of the substantially rectangular parallelepiped shape.

### (Fabrication of Circulation Mechanism)

A first cylindrical container having an internal volume substantially equal to that of the first chamber, a second cylindrical container having an internal volume substantially equal to that of the second chamber, and four rubber tubes are prepared. Each of the first cylindrical container and the second cylindrical container has connection terminals on an upper surface and a lower surface.

The first chamber of the substantially cubic container and the first cylindrical container are connected by two rubber tubes. Specifically, one end of one rubber tube is connected to the first opening portion of the first chamber, and the other end is connected to the connection terminal on the upper surface of the first cylindrical container. One end of another rubber tube is connected to the second opening portion of the first chamber, and the other end is connected to the connection terminal on the lower surface of the first cylindrical container. This rubber tube is connected to a pump for circulating the catholyte. As a result, the first chamber and the first cylindrical container are connected. Similarly, the second chamber and the second cylindrical container are connected by two rubber tubes. The rubber tube connecting the second opening portion of the second chamber and the connection terminal on the lower surface of the second cylindrical container is connected to a pump for circulating the anolyte.

### (Charging of Electrolytic Solution)

The substantially cubic container is provided such that the first opening portion is directed vertically upward. The first cylindrical container and the second cylindrical container are provided vertically downward from the upper surface to the lower surface.

The rubber tube is removed from the first opening portion of the first chamber, and the catholyte is charged from the first opening portion of the first chamber. The volume of the catholyte accounts for 80% of the total volume of the first chamber and the first cylindrical container. The first opening portion of the first chamber is connected to the removed rubber tube. As a result, in the first chamber, the catholyte comes into contact with the electrode disposed inside the first chamber. Similarly, the anolyte is charged in the second chamber. As a result, in the second chamber, the anolyte comes into contact with the electrode disposed inside the second chamber.

Thus, the redox flow battery of Example 1 is fabricated.

The redox flow battery of Example 1 includes an iron (III) aqueous solution-based electrolytic solution as a catholyte (first aqueous electrolytic solution) and an iron (II)-polylysine EDTA-based electrolytic solution as an anolyte (second aqueous electrolytic solution). In the redox flow battery of Example 1, an electrolytic solution of one of the catholyte and the anolyte is an electrolytic solution included in the scope of the disclosure according to claim 1.

In the redox flow battery of Example 1, a portion derived from ethylenediaminetetraacetic acid as a coordination moiety is bonded and included in the water-soluble chelate polymer. Therefore, in the anolyte (second aqueous electrolytic solution), the coordination moiety is less likely to diffuse through the diaphragm. Diffusion of the coordination moiety is suppressed in this manner, and thus the redox flow battery of Example 1 is less likely to deteriorate in battery performance.

### Example 2

A redox flow battery of Example 2 is fabricated in the same manner as in Example 1 except that the catholyte (first aqueous electrolytic solution) and the anolyte (second aqueous electrolytic solution) are different.

### (Catholyte: First Aqueous Electrolytic Solution)

The obtained peptide derivative [1] as a water-soluble chelate polymer, iron chloride (salt of iron) including a redox active material, deionized water as a solvent, and sodium hydroxide as an alkali adjusting agent are stirred using a stirrer (mixer) to obtain an iron (III)-polylysine EDTA aqueous solution-based electrolytic solution (pH=12). The obtained electrolytic solution was referred to as a catholyte (first aqueous electrolytic solution).

### (Anolyte: Second Aqueous Electrolytic Solution)

The peptide derivative [2] as a water-soluble chelate polymer, iron chloride (salt of iron) including a redox active material, deionized water as a solvent, and sodium hydroxide as an alkali adjusting agent are stirred using a stirrer (mixer) to obtain an iron (II)-polylysine DHEG aqueous solution-based electrolytic solution (pH=12). The obtained electrolytic solution is referred to as an anolyte (second aqueous electrolytic solution).

The peptide derivative [2] is synthesized by mixing and stirring ε-poly-L-lysine as a peptide and N,N-bis(2-hydroxyethyl)glycine (DHEG) in a molar ratio (ε-poly-L-lysine:DHEG) of 1:1 at room temperature (25° C.) for 5 hours to form an amide bond (peptide bond). This reaction is represented as the following reaction formula:

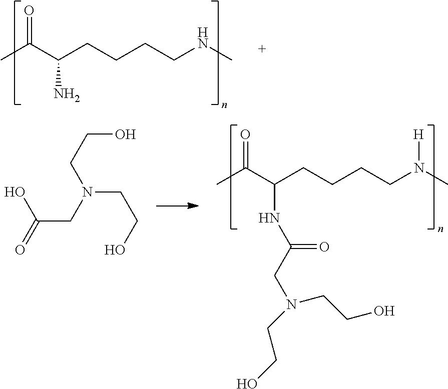

In the above reaction formula, n represents the degree of polymerization and represents a positive integer, in which a primary amino group (—NH₂) of the side chain of s-poly-L-lysine and a carboxyl group (—COOH) of N,N-bis(2-hydroxyethyl)glycine form an amide bond. This synthesizes the peptide derivative [2] in which DHEG is bonded to the side chain of ε-poly-L-lysine via an amide bond. The solubility of the peptide derivative [2] is 10 g/L.

The redox flow battery of Example 2 includes an iron (III)-polylysine EDTA aqueous solution based electrolytic solution as a catholyte (first aqueous electrolytic solution) and an iron (II)-polylysine TEOA aqueous solution based electrolytic solution as an anolyte (second aqueous electrolytic solution).

In the redox flow battery of Example 2, both catholyte and anolyte are electrolytic solutions included in the scope of the disclosure according to claim 1. As compared with Example 1, in the anolyte (second aqueous electrolytic solution), the coordination moiety is less likely to permeate the diaphragm and to diffuse, and also in the catholyte (first aqueous electrolytic solution), the coordination moiety is less likely to permeate the diaphragm and to diffuse. Diffusion of the coordination moiety is further suppressed in this manner, and thus the redox flow battery of Example 2 is further less likely to deteriorate in battery performance.

In addition, in the redox flow battery of Example 2, comparison between the catholyte and anolyte indicates a difference in only the coordination moiety of the water-soluble chelate polymer. As described above, a significant potential difference can be formed by modifying only the coordination moiety in both electrolytic solutions. That is, modifying the coordination moiety of the water-soluble chelate polymer can modulate, for example, the redox potential of the redox flow battery and the potential difference therebetween according to a desired application and performance.

Further, the redox flow battery of Example 2 is common in that the redox active material is an iron ion. Therefore, the diaphragm is impermeable to only specific chemical species (for example, hydroxide ions), but if a small amount of redox active materials permeate each other, the performance of the redox flow battery is less likely to deteriorate because only the valence is different.

### Example 3

A redox flow battery of Example 3 is fabricated in the same manner as in Example 1 except that the catholyte (first aqueous electrolytic solution) is different.

### (Catholyte: First Aqueous Electrolytic Solution)

The obtained peptide derivative [1] as a water-soluble chelate polymer, manganese chloride (salt of manganese) including a redox active material, deionized water as a solvent, and sodium hydroxide as an alkali adjusting agent are stirred using a stirrer (mixer) to obtain a manganese (III)-polylysine EDTA aqueous solution-based electrolytic solution (pH=8). The obtained electrolytic solution was referred to as a catholyte (first aqueous electrolytic solution).

In the redox flow battery of Example 3, both catholyte and anolyte are electrolytic solutions included in the scope of the disclosure according to claim 1. As compared with Example 1, in the anolyte (second aqueous electrolytic solution), the coordination moiety is less likely to permeate the diaphragm and to diffuse, and also in the catholyte (first aqueous electrolytic solution), the coordination moiety is less likely to permeate the diaphragm and to diffuse. Diffusion of the coordination moiety is further suppressed in this manner, and thus the redox flow battery of Example 3 is further less likely to deteriorate in battery performance.

In addition, in the redox flow battery of Example 3, comparison between the catholyte and the anolyte indicates that only the redox active material is different. As described above, changing only the redox active material in both the electrolytic solutions allows a significant potential difference to be formed. That is, changing the redox active material can modulate, for example, the redox potential of the redox flow battery and the potential difference therebetween according to a desired application and performance.

### Example 4

A redox flow battery of Example 4 is fabricated in the same manner as in Example 1 except that the anolyte (second aqueous electrolytic solution) is different.

### (Anolyte: Second Aqueous Electrolytic Solution)

The peptide derivative [3] as a water-soluble chelate polymer, iron chloride (salt of iron) including a redox active material, deionized water as a solvent, and sodium hydroxide as an alkali adjusting agent are stirred using a stirrer (mixer) to obtain an iron (II)-polylysine EDTA/DHEG aqueous solution-based electrolytic solution (pH=8). The obtained electrolytic solution is referred to as an anolyte (second aqueous electrolytic solution).

For the peptide derivative [3], ε-poly-L-lysine as a peptide and ethylenediaminetetraacetic acid (EDTA) and N,N-bis(2-hydroxyethyl)glycine (DHEG) (molar ratio: EDTA/DHEG=1/1) were mixed and stirred under the conditions of a molar ratio (ε-poly-L-lysine: [EDTA+DHEG]) of 1:1, room temperature (25° C.) and 5 hours. This reaction is represented by the following reaction formula:

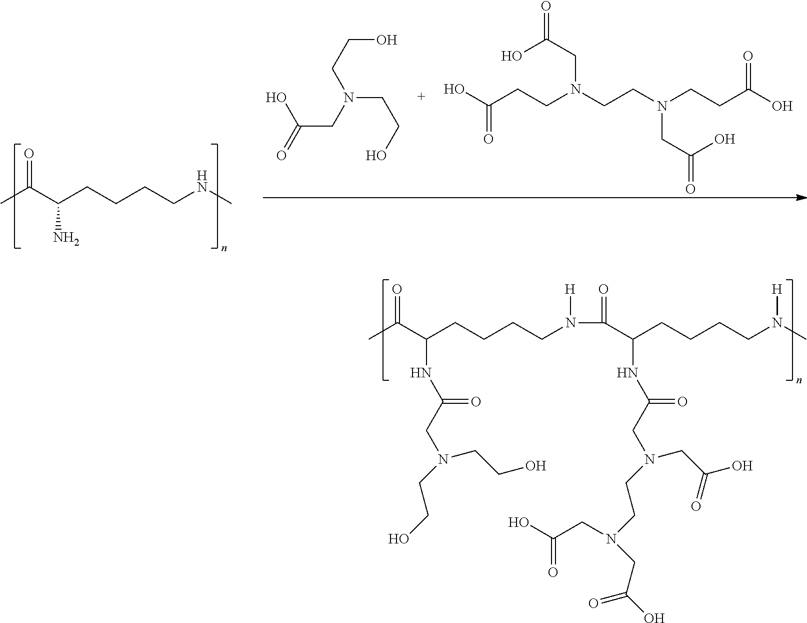

In the above reaction formula, n represents the degree of polymerization and represents a positive integer, in which this is a dehydration condensation reaction in which a primary amino group (—NH₂) of a side chain of ε-poly-L-lysine and a carboxyl group (—COOH) of ethylenediaminetetraacetic acid (EDTA) and N,N-bis(2-hydroxyethyl)glycine (DHEG) form an amide bond (peptide bond). This synthesizes a peptide derivative [3] in which EDTA and DHEG are bonded to the side chain of ε-poly-L-lysine via an amide bond. The solubility of the peptide derivative [3] is 10 g/L.

The redox flow battery of Example 4 includes an iron (II)-polylysine EDTA/DHEG aqueous solution-based electrolytic solution as an anolyte (second aqueous electrolytic solution) and an iron (III) aqueous solution-based electrolytic solution as a catholyte. In the redox flow battery of Example 4, an electrolytic solution of one of the catholyte and the anolyte is an electrolytic solution included in the scope of the disclosure according to claim 1.

In the redox flow battery of Example 4, moieties derived from ethylenediaminetetraacetic acid and N,N-bis(2-hydroxyethyl)glycine as coordination moieties are included in the water-soluble chelate polymer in a bonded manner. Therefore, in the anolyte (second aqueous electrolytic solution), the coordination moiety is less likely to diffuse through the diaphragm. Diffusion of the coordination moiety is suppressed in this manner, and thus the redox flow battery of Example 1 is less likely to deteriorate in battery performance.

In addition, in the redox flow battery of Example 4, the plurality of coordination moieties included in one molecule of the peptide derivative [3] are coordination moieties derived from ethylenediaminetetraacetic acid (EDTA) and coordination moieties derived from N,N-bis(2-hydroxyethyl)glycine (DHEG). For this reason, a plurality of coordination moieties included in one molecule of the peptide derivative [3] are different. As described above, the types of the plurality of coordination moieties in one molecule of the water-soluble chelate polymer are different, and thus the redox potential of the electrolytic solution can be finely adjusted.

The electrolytic solution for a redox flow battery according to the present disclosure can be used by being mounted on a redox flow battery. In addition, the redox flow battery according to the present disclosure can be used as a storage battery of electric power generated in a power plant and a power generator.

### DESCRIPTION OF REFERENCE SYMBOLS

1: Redox flow battery
2: Electric cell
21A: First chamber
211A: First electrode
213A: First aqueous electrolytic solution
21B: Second chamber
211B: Second electrode
213B: Second aqueous electrolytic solution
25: Diaphragm
3: Electrolytic solution tank
31A: First electrolytic solution tank
31B: Second electrolytic solution tank
4: Electrolytic solution circulation path
41A: First electrolytic solution circulation path
41B: Second electrolytic solution circulation path
5: Pump
51A: First electrolytic solution circulation pump
51B: Second electrolytic solution circulation pump
100: Power converter (power conditioner, DC/AC converter)
200: Power generation unit
300: Load unit

1. An electrolytic solution for a redox flow battery, the electrolytic solution comprising:
a substance including a metal ion;
a water-soluble polymer having at least one coordination moiety on a side chain, wherein the at least one coordination moiety coordinates with the metal ion to form a metal complex; and
an aqueous solvent.

2. The electrolytic solution for a redox flow battery according to claim 1, wherein the water-soluble polymer is a polyamine derivative.

3. The electrolytic solution for a redox flow battery according to claim 1, wherein the water-soluble polymer includes a nitrogen atom and an oxygen atom.

4. The electrolytic solution for a redox flow battery according to claim 1, wherein the water-soluble polymer is a peptide derivative.

5. The electrolytic solution for a redox flow battery according to claim 4, wherein the peptide derivative includes a repeating unit derived from lysine.

6. The electrolytic solution for a redox flow battery according to claim 1, wherein the metal ion is an ion selected from the group consisting of Zn, Fe, Ti, Cu, Co, Ce, Cr, and Mn.

7. The electrolytic solution for a redox flow battery according to claim 1, wherein the metal ion is an iron ion.

8. The electrolytic solution for a redox flow battery according to claim 1, wherein the electrolytic solution is an alkaline aqueous solution.

9. The electrolytic solution for a redox flow battery according to claim 1, wherein the at least one coordination moiety is derived from a ligand selected from the group consisting of ethylenediaminetetraacetic acid (EDTA), ethylenediaminebis(2-hydroxyphenyl)acetic acid (EDDHA), diethylenetriaminepentaacetic acid (DTPA), and triethanolamine (TEOA) and/or at least one functional group selected from the group consisting of a hydroxy group, a carboxy group, a phosphate group, a sulfo group, a phenol group, and a pyridine group.

10. The electrolytic solution for a redox flow battery according to claim 1, wherein the at least one coordination moiety comprises a plurality of different coordination moieties.

11. A redox flow battery comprising:
an electric cell having:
a first chamber having a first electrode and a first aqueous electrolytic solution in contact with the first electrode;
a second chamber having a second electrode and a second aqueous electrolytic solution in contact with the second electrode; and
a diaphragm that partitions the first chamber and the second chamber and electrically isolates the first aqueous electrolytic solution and the second aqueous electrolytic solution from each other, and
an electrolytic solution tank having:
a first electrolytic solution tank that is connected to the first chamber and stores the first aqueous electrolytic solution; and
a second electrolytic solution tank that is connected to the second chamber and stores the second aqueous electrolytic solution,
wherein at least one of the first aqueous electrolytic solution and the second aqueous electrolytic solution is the electrolytic solution for the redox flow battery according to claim 1.

12. The redox flow battery according to claim 11, wherein the first aqueous electrolytic solution and the second aqueous electrolytic solution are the electrolytic solution for the redox flow battery, and
the substance in the first aqueous electrolytic solution and the substance in the second aqueous electrolytic solution are the same.

13. The redox flow battery according to claim 11, wherein the substance is an iron ion.

14. The redox flow battery according to claim 12, wherein the at least one coordination moiety of the water-soluble polymer in the first aqueous electrolytic solution and the at least one coordination moiety of the water-soluble polymer in the second aqueous electrolytic solution are different from each other.

15. The redox flow battery according to claim 11, wherein
both the first aqueous electrolytic solution and the second aqueous electrolytic solution are the electrolytic solution for the redox battery,
the at least one coordination moiety of the water-soluble polymer in the first aqueous electrolytic solution and the at least one coordination moiety of the water-soluble polymer in the second aqueous electrolytic solution are the same, and
the substance in the first aqueous electrolytic solution and the substance in the second aqueous electrolytic solution are ions of at least one metal selected from the group consisting of Zn, Fe, Ti, Cu, Co, Ce, Cr, and Mn, and are different from each other.

16. The redox flow battery according to claim 11, wherein the at least one coordination moiety comprises a plurality of coordination moieties, and the plurality of coordination molecules included in one molecule of the water-soluble polymer are different.

17. The redox flow battery according to claim 11, wherein the water-soluble polymer is a polyamine derivative.

18. The redox flow battery according to claim 11, wherein the water-soluble polymer includes a nitrogen atom and an oxygen atom.

19. The redox flow battery according to claim 11, wherein the water-soluble polymer is a peptide derivative.

20. The redox flow battery according to claim 19, wherein the peptide derivative includes a repeating unit derived from lysine.
